(19) United States
(12) Patent Application Publication
(10) Pub. No.: US 2007/0280273 A1
(43) Pub. Date: Dec. 6, 2007

(54) Method and apparatus to perform handover enhancing throughput

(75) Inventors: Won-dong Yun, Seoul (KR); Young-Keun Kim, Incheon (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/641,095

(22) Filed: Dec. 19, 2006

(30) Foreign Application Priority Data
Jun. 1, 2006 (KR) 2006-49192

(51) Int. Cl. H04L 12/56

(52) U.S. Cl. 370/401; 370/252

(57) ABSTRACT

A method and apparatus to perform a handover of a mobile terminal that is receiving data, wherein before the handover is performed, the mobile terminal receiving data from a host provides information about a new network to the host by using a quick-start (QS) request message. Accordingly, the host recognizes that a packet loss caused by the handover is not caused by network congestion, and sets the size of a congestion window based on the information on the new network. Accordingly, waste of bandwidth can be reduced compared to that of a conventional slow-start algorithm.

### CROSS-REFERENCE TO RELATED APPLICATION

This application claims the benefit of Korean Patent Application No. 2006-49192, filed on Jun. 1, 2006, in the Korean Intellectual Property Office, the disclosure of which is incorporated herein in its entirety by reference.

### BACKGROUND OF THE INVENTION

1. Field of the Invention

Aspects of the present invention relate to communication of a mobile terminal, and more particularly, to a method of performing a handover of a mobile terminal that is receiving data.

2. Description of the Related Art

With the development of mobile communication technologies and changes in the communication environment, a variety of communication protocols have been developed. Among one of the most widely used protocols, transmission control protocol (TCP) is a connection-oriented protocol that enables a sender to reliably transmit data to a receiver.

In general, the TCP operates based on a slow-start. That is, when a sender begins to transmit data to a receiver, data is transmitted from a smallest transmission unit. However, this algorithm results in a waste of bandwidth. Accordingly, a quick-start algorithm has been introduced such that when a receiver provides a sender with bandwidth information available with respect to a current network state, data is not automatically transmitted from the smallest transmission unit. Rather, the bandwidth at the start of transmission is determined according to the received information.

FIG. 1 illustrates a format of a quick-start (QS) request message that is used by a receiver to provide a sender with network information.

Available bandwidth information is recorded in a rate request field, which is one of the fields illustrated in FIG. 1. If the bandwidth that can be processed by each router provided on a communication path between the sender and the receiver is lower than a value recorded in the rate request field, the router changes the field value into a bandwidth value that can be processed by the router.

Accordingly, if the sender that is to transmit data receives the QS request message, the sender can determine a start transmission rate. By transmitting a response message, the sender completes preparation of data transmission. Since details of other fields included in the QS request message are explained in the TCP standard, a detailed explanation will be omitted here.

FIG. 2 illustrates a process of performing a 3-way handshake using a quick-start message. In general, in order to communicate using the TCP protocol, a 3-way handshake procedure is performed between a sender and a receiver.

The 3-way handshake includes three operations. First, the sender transmits a SYN packet including an initial sequence number (ISN) of a host and a SYN flag set to 1. The receiver adds 1 to the received ISN, sets the resultant value as an acknowledgement number, sets the SYN flag to 1, and transmits a SYN/ACK packet to the sender. The sender transmits a message in response to the SYN/ACK packet. Then, the setting of a TCP session is completed and preparation for data communication is finished.

As illustrated in FIG. 2, the QS algorithm can be implemented by adding a QS request and/or a QS response message to the SYN, SYN/ACK, and ACK segments in the ordinary 3-way handshake and transmitting the packets. That is, the sender includes a QS request message in the IP header of the SYN packet and transmits the SYN packet to the receiver. At this time, in the rate request field of the QS request message, the bandwidth information about the bandwidth at a transmission start time is included. A router in the transmission path receiving the QS request message changes, if necessary, the rate request value of the QS request message into a value that can be processed by the router, and transfers the message to the receiver. Though only one router is shown between the sender and the receiver in FIG. 2, it is understood by those of ordinary skill in the art of the present invention that a plurality of routers can exist in the communication path between the sender and the receiver.

Meanwhile, when the receiver receives the QS request message, the receiver analyzes the QS request message, sets an appropriate value as a rate request, and then generates a QS request message. The generated QS request message is included in the IP header of a SYN/ACK packet and transmitted to the sender. The TCP header of this SYN/ACK packet includes a response message to the QS request message received by the receiver. As in the SYN packet, the rate request field value of the QS request message included in the SYN/ACK packet is also changed by routers in the process of transmission to the sender. When the SYN/ACK packet is received, the sender determines the bandwidth at a transmission start time by referring to the rate request field value of the QS request message, includes a response message to the QS request message in the TCP header of an ACK packet, and transmits the ACK packet to the receiver. If a TCP session is set by this series of processes, the sender does not perform the slow-start algorithm in which data transmission begins from the smallest transmission unit. Rather, the sender begins transmission of data at a bandwidth appropriate to the state of a network. In this way, efficient transmission of data is enabled.

However, this QS algorithm does not consider the mobility of a receiver. That is, when a mobile terminal receiving data is handed over from a current network to another network, a packet loss due to timeout generally occurs while the handover is performed. If this packet loss occurs, the congestion window size is set to 1 in the TCP protocol and a slow-start algorithm is performed.

In other words, even when a packet loss occurs due to the handover, the TCP regards the loss as having occurred due to congestion, performs flow control, and the slow-start algorithm is thus performed. Accordingly, a long time is required for the transmission rate to converge to an appropriate bandwidth of a new network, thus wasting the bandwidth.

### SUMMARY OF THE INVENTION

Aspects of the present invention provide a method and apparatus by which, when a packet loss occurs due to a handover of a mobile terminal receiving data, a host transmitting data sets the size of a congestion window with respect to the bandwidth of a network.

According to an aspect of the present invention, there is provided a method of performing a handover of a mobile terminal receiving data from a remote host, from a first network to a second network, the method including: transmitting bandwidth information of the second network to the host; if it is recognized that the host receives the information, performing the handover to the second network; and informing the host that the handover is completed.

In the transmitting of the bandwidth information of the second network to the host, a QS request message that is used in a transmission control protocol (TCP) may be transmitted to the host, and in a rate request field of the QS request message, information about a bandwidth to be applied in the second network may be included, and in a reserved field, information indicating that the QS message relates to the handover may be included.

The method may further include: receiving another QS request message from the host that recognizes that the handover is completed; and transmitting a QS response message in response to the received other QS request message, to the host.

According to another aspect of the present invention, there is provided a computer readable recording medium having embodied thereon a computer program to execute the method of performing the handover.

According to another aspect of the present invention, there is provided a mobile terminal apparatus to perform a handover from a first network to a second network, while receiving data from a remote host, the apparatus including: a network information transfer unit to transmit bandwidth information of the second network to the host; and a handover performing unit to control the mobile terminal apparatus, if it is determined that the host receives the information, to perform the handover of the mobile terminal apparatus to the second network, and informing the host that the handover is completed.

According to still another aspect of the present invention, there is provided a method of transmitting data to a mobile terminal, the method including: receiving a QS request message from the mobile terminal while transmitting data to the mobile terminal; if a packet loss occurs, determining based on the QS message whether the packet loss is caused by the handover of the mobile terminal; and controlling the transmission rate of the data based on the determination result.

In the controlling of the transmission rate of the data, if it is determined that the packet loss is caused by the handover of the mobile terminal, and if it is determined that the handover of the mobile terminal is completed, the transmission rate may be determined based on the rate field value of the QS request message.

According to another aspect of the present invention, there is provided a computer readable recording medium having embodied thereon a computer program to execute the method of transmitting data.

According to yet another aspect of the present invention, there is provided an apparatus to transmit data to a mobile terminal, the apparatus including: a determination unit to, if a packet loss occurs while data is transmitted to the mobile terminal, determine based on a QS message received from the mobile terminal, whether the packet loss is caused by the handover of the mobile terminal; and a transmission rate control unit to control the transmission rate of the data based on the determination result.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates a format of a conventional quick-start request message;

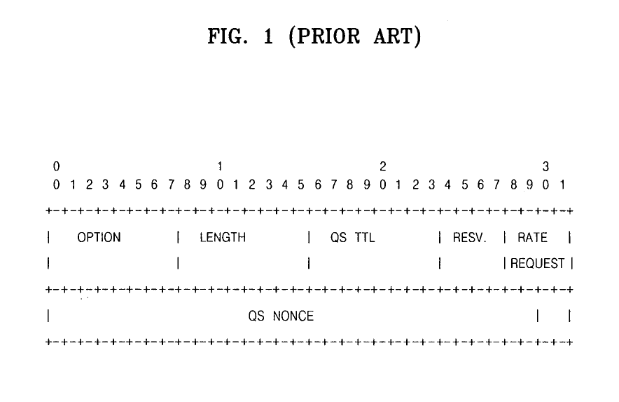

FIG. 2 illustrates a process of performing a 3-way handshake using a quick-start message;

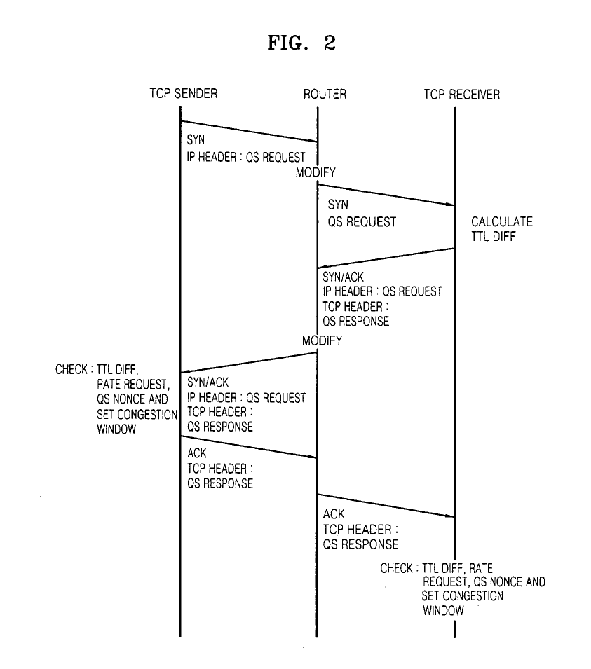

FIG. 3 is a diagram illustrating a method of performing a handover according to an embodiment of the present invention;

FIG. 4 is a flowchart illustrating a process of performing a handover according to an embodiment of the present invention;

FIG. 5 is a flowchart illustrating a process of transmitting data to a mobile terminal according to an embodiment of the present invention;

FIG. 6 is a block diagram illustrating the structure of a mobile terminal and a host according to an embodiment of the present invention;

FIGS. 7A and 7B are graphs illustrating throughput when a handover of a mobile terminal is performed from a current network to a network having a lower bandwidth than that of the current network; and

FIGS. 8A and 8B are graphs illustrating throughput when a handover of a mobile terminal is performed from a current network to a network having a higher bandwidth than that of the current network.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

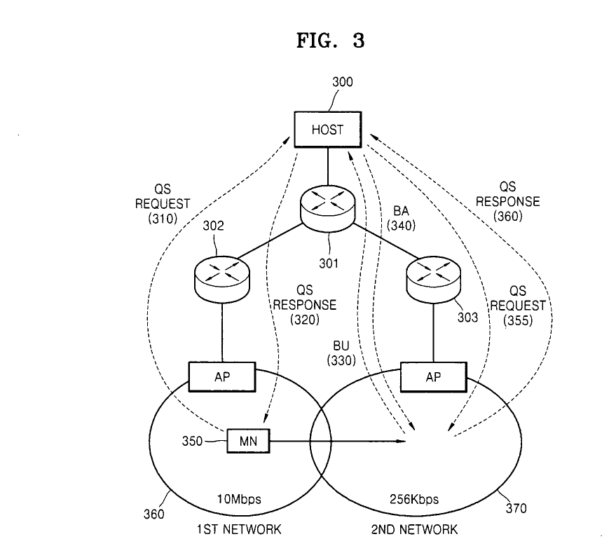

FIG. 3 is a diagram illustrating a method of performing a handover according to an embodiment of the present invention. In the current embodiment, it is assumed that a mobile terminal 350 that is receiving data from a host 300 is handed over from a first network 360 having a bandwidth of 10 Mbps to a second network 370 having a bandwidth of 256 kbps.

If the mobile terminal 350 senses the presence of the second network 370, the mobile terminal 350 transmits information about the bandwidth of the second network 370 to the host 300 by using a quick-start (QS) request message 310. At this time, the bandwidth information of the second network 370 is recorded in the rate request field of the QS request message 310. A flag indicating that the QS request message 310 relates to a handover is recorded in a reserved field. For example, a flag, H, may be recorded, and if the QS request message 310 relates to a handover, the H flag value may be set to 1. While the QS request message 310 is transferred to the host 300, routers 301 and 302 existing between the mobile terminal 350 and the host 300 determine that the H flag is set to 1 and thus do not change the rate request field value. Accordingly, the host 300 can receive the bandwidth information of the second network 370 transmitted by the mobile terminal 350.

The mobile terminal 350 determines from the QS response message 320 that the host 300 received the bandwidth information of the second network 370. When the mobile terminal 350 performs a handover to the second network 370, the mobile terminal 350 informs the host 300 of the completion of the handover through a binding update message 330. The host 300 determines from the binding update message 330 that the mobile terminal 350 performed the handover operation, and transmits a response message 340 to the mobile terminal 350. Also, based on the bandwidth information of the second network 370 received through the QS request message 310, the host 300 determines a transmission rate, that is, the size of a congestion window to be used for data transmission after a packet loss occurs due to the handover. However, it is understood that the binding update message 330 may include the rate request field with the bandwidth information of the second network 370. Likewise, it is understood that the binding update message 330 may be transmitted with another QS request message (not shown). Accordingly, routers 303 and 301 existing between the mobile terminal 350 and the host 300 may change the rate request field value to a bandwidth value that can be processed by the router 303 and 301 if the bandwidth that can be processed by each router 303 and 301 is lower than the rate request field value.

At this time, the host may transmit data to the mobile terminal 350 at the transmission rate determined based on the bandwidth information of the second network 370. Furthermore, the host 300 may transmit another QS request message 355 to the mobile terminal 350 and, when receiving a QS response message 360 in response to the other QS request message 355, the host 300 may identify the network state and determine a final transmission rate. That is, this QS request message 355 is not for indicating the bandwidth information of a network during handover, as is the case with the first QS request message 310, but is a QS request message to determine a value of a transmission rate after a packet loss occurs. The QS request message 355 may result in appropriately adjusting the transmission rate of the first QS request message 310 to factor in, for example, the degree of network congestion.

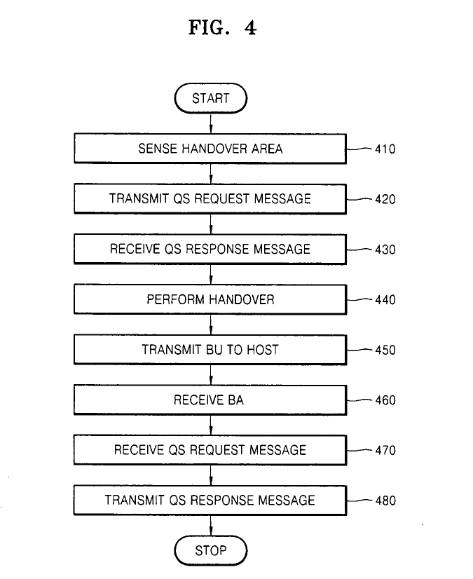

FIG. 4 is a flowchart illustrating a process of performing a handover according to an embodiment of the present invention.

In operation 410, a mobile terminal 350 receiving data from a host 300 senses the presence of a new network 370. That is, the mobile terminal 350 senses that it is in a handover area. The mobile terminal 350 can sense the presence of a new network 370 through a variety of methods. For example, by receiving an access network identification (ANID) transmitted by a point coordination function (PCF) of a code division multiple access (CDMA) network, or a beacon transmitted by an access point of a wireless local area network (WLAN), the mobile terminal 350 can sense a handover area.

In operation 420, the mobile terminal 350 transmits a QS request message 310 to the host 300. At this time, the bandwidth information of the new network 370 is recorded in the rate request field of the QS request message 310 and the H flag indicating that the QS request message 310 relates to a handover is set to 1.

In operation 430, a response message 320 to the QS request message 310 is received from the host 300. In operation 440, the mobile terminal 350 performs a handover to the new network 370. In operation 450, the mobile terminal 350 transmits a binding update message 330 indicating that the handover is completed. In operation 460, the mobile terminal 350 receives a response message 340 to the binding update message 330 from the host 300.

The mobile terminal 350 receiving the binding update response message 340 in operation 460 receives a QS request message 355 from the host 300 in operation 470, and transmits a response message 360 to the QS request message 355 in operation 480.

That is, before the handover is performed, the mobile terminal 350 transmits information on the new network 370 to the host 300. When the mobile terminal 350 determines that the host 300 receives the information on the new network 370, the mobile terminal 350 performs the handover. Then, the mobile terminal 350 informs the host 300 of the completion of the handover so that the host 300 can determine the size of a congestion window based on the information on the new network.

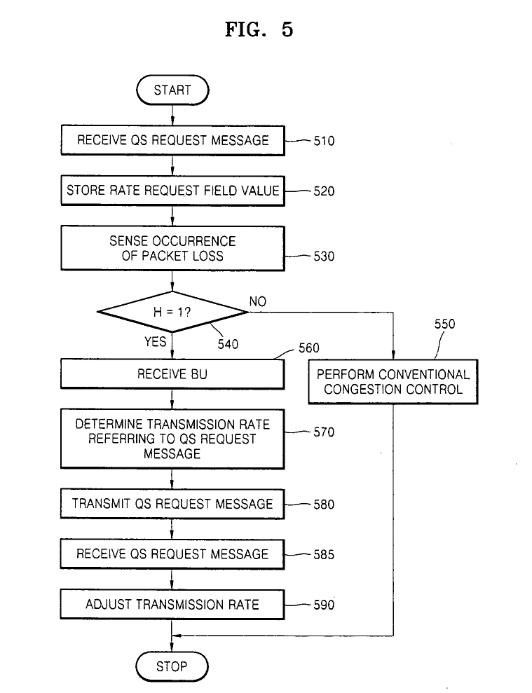

FIG. 5 is a flowchart illustrating a process in which a host 300 transmitting data to a mobile terminal 350 responds to the handover of the mobile terminal 350 according to an embodiment of the present invention.

In operation 510, the host 300 receives a QS request message 310 from the mobile terminal 350.

In operation 520, the host 300 stores the rate request field value of the received QS request message 310 in a memory. In operation 530, the host 300 senses a packet loss. In operation 540, the host 300 determines whether the sensed packet loss is caused by the handover of the mobile terminal 350 or by network congestion by referring to the H flag of the QS request message received in operation 510. If the packet loss is caused by network congestion (i.e., the H flag value is 0), the host 300 performs conventional congestion control (i.e., a slow-start algorithm) in operation 550.

If the packet loss sensed in operation 530 is caused by the handover of the mobile terminal 350 (i.e., the H flag value is 1), the host receives 300 a binding update message 330 from the mobile terminal 350 indicating the completion of the handover in operation 560.

In operation 570, the host 300 determines a transmission rate by referring to the rate request field value stored in operation 520. That is, the initial value of the size of a congestion window is not set to 1, as would be with the slow-start algorithm, but is set to a value corresponding to the rate request field value.

In operation 580, the host 300 generates a QS request message 355 and transmits the message 355 to the mobile terminal 350. Here, the QS request message 355 is different in nature than the QS request message 310 in operation 510, and does not have the H flag or has the H flag set to 0. That is, the current QS request message 355 is a QS request message 355 in its ordinary meaning in that the current QS request message 355 is used to identify a bandwidth available in a network.

In operation 585, the host 300 receives a QS response message 360 from the mobile terminal 350. Then, in operation 590, the host 300 adjusts the transmission rate determined in operation 570 by referring to the rate request field of the received QS response message 360.

That is, the host 300 may transmit data at the transmission rate determined in operation 570 if the handover of the mobile terminal 350 is finished. However, according to other aspects, the host 300 may perform operations 580 and 590 in order to appropriately adjust the determined transmission rate with respect to the degree of network congestion.

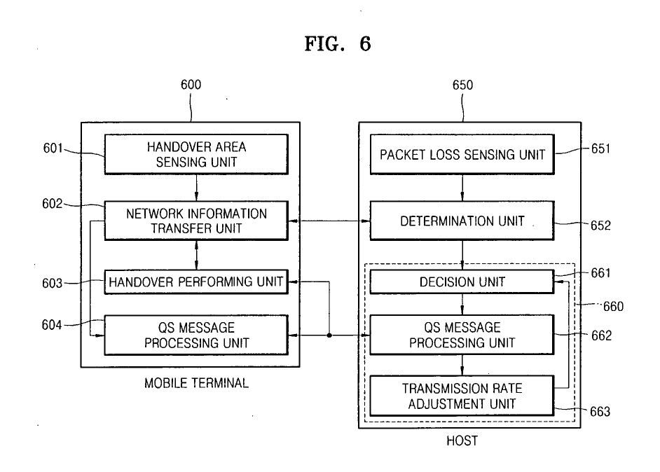

FIG. 6 is a block diagram illustrating the structure of a mobile terminal 600 and a host 650 according to an embodiment of the present invention. In the current embodiment, it is assumed that a mobile terminal 600 is handed over from a first network 360 to a second network 370.

Referring to FIG. 6, the mobile terminal 600 includes a handover area sensing unit 601, a network information transfer unit 602, a handover performing unit 603, and a QS message processing unit 604.

The handover area sensing unit 601 senses the presence of a new network through channels of a variety of frequency bands, and senses that the mobile terminal 600 is in a handover area. Here, the handover area is an area where two networks overlap each other.

When the handover area sensing unit 601 determines that the mobile terminal 600 is in a handover area the network information transfer unit 602 collects information of the second network 370 and transfers the information to the host 650 through a QS request message 310. At this time, the bandwidth information of the second network 370 is included in the rate request field of the QS request message 310, and an H flag indicating handover of the mobile terminal 600 is included in a reserved field. Also, the network information transfer unit 602 receives a QS response message 320 as a response to the QS request message 310.

When the network information transfer unit 602 receives the QS response message 320, the handover performing unit 603 controls the mobile terminal 600 to perform a handover. When the handover is completed, the mobile terminal 600 informs the host 650 of the completion by transmitting a binding update message 330 to the host 650.

After the handover is completed, the QS message processing unit 604 receives a QS request message 355 from the host 650 and transmits a QS response message 360 as a response to the received QS request message 355. As described above, the QS request message 355 and the QS response message 360 at this time are to identify the state of the network and to adjust the size of a congestion window, and thus are different in nature from the QS request message 310 and the QS response message 320 transmitted and received by the network information transfer unit 602.

Meanwhile, the host 650, according to an embodiment of the present invention, includes a packet loss sensing unit 651, a determination unit 652, and a transmission rate control unit 660. The transmission rate control unit 660 includes a decision unit 661, a QS message processing unit 662, and a transmission rate adjustment unit 663.

The packet loss sensing unit 651 senses, based on an ACK signal transmitted to the mobile terminal 600, whether a packet loss occurs. If a packet loss occurs, the determination unit 651 determines whether the cause of the packet loss is the handover of the mobile terminal 600. The transmission rate control unit 660 controls the transmission rate based on the determination result of the determination unit 652.

The determination unit 652 receives a QS request message 310 from the mobile terminal 600, and by analyzing the message, determines whether there will be a handover of the mobile terminal 600. If the analysis result indicates that the H flag is set to 1, the determination unit 652 determines that the mobile terminal 600 is to perform a handover, and a QS response message 320 as a response to the QS request message 310 is transmitted to the mobile terminal 600. Here, the H flag included in the QS request message 310 is set to 1. If the analysis result indicates that the H flag does not exist, or the H flag is set to 0, the determination unit 652 determines that the packet loss is caused by, for example, network congestion and ordinary congestion control (i.e., a slow-start algorithm) is performed.

The decision unit 661 receives a binding update message 330 from the mobile terminal 600 and determines the transmission rate (i.e., the size of a congestion window) by referring to the rate request field value of the QS request message 310 received by the determination unit 652. When the decision unit 662 receives the binding update message 330, the QS message processing unit 662 generates a QS request message 355 and transmits the message 355 to the mobile terminal 600. The QS message processing unit 662 also receives a QS response message 360 as a response to the QS request message 355. The QS request message 355 and the QS response message 360 here are different in nature from the QS messages 310 and 320 transmitted and received by the determination unit 652 and do not have the H flag or have the H flag set to 0.

The transmission rate adjustment unit 663 adjusts the size of a congestion window determined in the decision unit 661 based on the rate request field of the QS response message 360 received by the QS message processing unit 662.

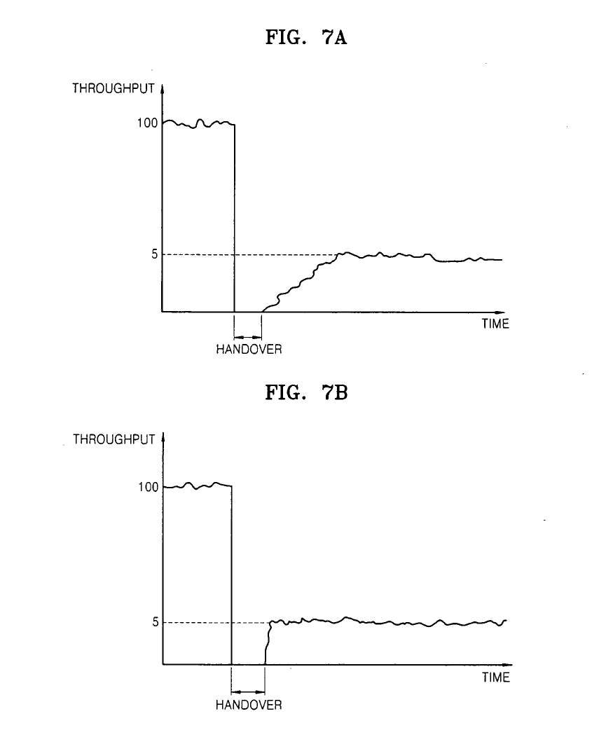

FIGS. 7A and 7B are graphs illustrating throughput when a handover of a mobile terminal 600 from a first network having a bandwidth of 100 Mbps to a second network having a bandwidth of 5 Mbps is performed.

FIG. 7A illustrates the throughput according to conventional technology and FIG. 7B illustrates the throughput according to an embodiment of the present invention.

First, referring to FIG. 7A, while receiving data from the first network at a transmission rate of 100 Mbps, the mobile terminal 600 performs a handover to the second network. While the handover is performed, a packet loss caused by a timeout occurs. The TCP protocol regards this loss as caused by network congestion, and after the handover is completed, a slow-start algorithm is performed. As a result, the throughput graph illustrated in FIG. 7A is obtained.

Meanwhile, referring to FIG. 7B, before performing handover, the mobile terminal 600 transmits the bandwidth information of the second network to a host 650 through a QS request message 310. The host 650 receives the message 310, and even though a packet loss occurs within a predetermined time, the host 650 recognizes that the packet loss is caused not by network congestion, but by the handover of the mobile terminal 600. Accordingly, if the completion of the handover is informed through a binding update message 330, the host 650 does not perform a slow-start algorithm, and fixedly sets the size of a congestion window to 5 Mbps. As a result, the throughput graph illustrated in FIG. 7B is obtained.

By comparing FIGS. 7A and 7B, it can be seen that a time taken to reach 5 Mbps, which is the available bandwidth of the second network, after the packet loss occurs is much shorter in FIG. 7B than in FIG. 7A.

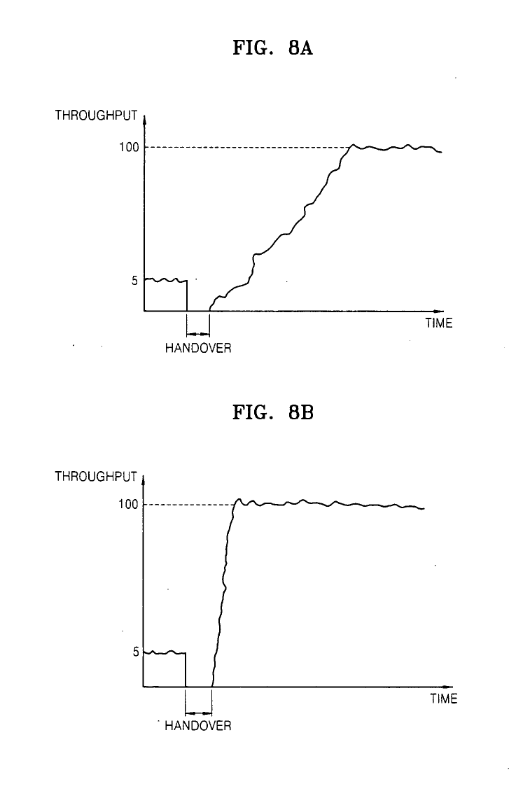

FIGS. 8A and 8B are graphs illustrating throughput when a handover of a mobile terminal 600 from a first network having a bandwidth of 5 Mbps to a second network having a bandwidth of 100 Mbps is performed.

First, referring to FIG. 8A, while receiving data from the first network at a transmission rate of 5 Mbps, the mobile terminal 600 performs a handover to the second network. While the handover is performed, a packet loss caused by a timeout occurs. The TCP protocol regards this loss as caused by network congestion, and after the handover is completed, a slow-start algorithm is performed. As a result, the throughput graph illustrated in FIG. 8A is obtained.

Meanwhile, referring to FIG. 8B, before performing handover, the mobile terminal 600 transmits the bandwidth information of the second network to a host 650 through a QS request message 310. The host 650 receives the message 310, and even though a packet loss occurs within a predetermined time, the host 650 recognizes that the packet loss is caused not by network congestion, but by the handover of the mobile terminal 600. Accordingly, if the completion of the handover is indicated by a binding update message 330, the host 650 does not perform a slow-start algorithm, and fixedly sets the size of a congestion window to 100 Mbps. As a result, the throughput graph illustrated in FIG. 8B is obtained.

Also, by comparing FIGS. 8A and 8B, it can be seen that a time taken to reach 100 Mbps, which is the available bandwidth of the second network, after the packet loss occurs is much shorter in FIG. 8B than in FIG. 8A.

Aspects of the present invention can also be embodied as computer-readable codes on a computer-readable recording medium. The computer-readable recording medium is any data storage device that can store data which can be thereafter read by a computer system. Examples of the computer-readable recording medium include read-only memory (ROM), random-access memory (RAM), CD-ROMs, magnetic tapes, floppy disks, optical data storage devices, and a computer data signal embodied in a carrier wave including a compression source code segment and an encryption source code segment (such as data transmission through the Internet).

According to aspects of the present invention, a concept of mobility is introduced into the conventional QS algorithm. Even when a packet loss occurs during the handover of a mobile terminal, the host transmitting data can quickly change the transmission rate to a bandwidth that is acceptable to a new network. Accordingly, compared to the conventional slow-start algorithm, waste of bandwidth can be reduced.

Also, by transferring information about a new network to the host through a QS request message, a separate packet does not need to be used. Accordingly, aspects of the present invention can also reduce cost.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A method of performing a handover, from a first network to a second network, of a mobile terminal receiving data from a remote host, the method comprising:
transmitting bandwidth information of the second network to the host; and
performing the handover to the second network after the host receives the bandwidth information; and
receiving the data from the host through the second network with a start transmission rate determined by the host according to the transmitted bandwidth information.

2. The method as claimed in claim 1, further comprising:
informing the host that the handover is completed before the receiving of the data from the host.

3. The method as claimed in claim 1, wherein the transmitting of the bandwidth information of the second network comprises:
storing the bandwidth information of the second network in a rate request field comprised in a quick-start (QS) request message that is used in a transmission control protocol (TCP); and transmitting the QS request message to-the host .

4. The method as claimed in claim 3, wherein the transmitting of the bandwidth information of the second network further comprises:
storing information indicating that the QS request message relates to the handover in a reserved field comprised in the QS request message before the transmitting of the QS request message.

5. The method as claimed in claim 3, further comprising:
receiving a QS response message from the host to confirm that the host received the bandwidth information before the performing of the handover.

6. The method as claimed in claim 1, further comprising:
receiving a QS request message from the host after the receiving of the data from the host;
storing the bandwidth information in a QS response message that is updatable by a router located in a connection path between the mobile terminal and the host; and
transmitting the QS response message in response to the received QS request message to the host, wherein
the host determines a final transmission rate of the data based on the updated bandwidth information.

7. The method as claimed in claim 1, further comprising:
transmitting a binding update message to the host to inform the host that the handover is completed before the receiving of the data from the host.

8. The method as claimed in claim 7, wherein the transmitting of the binding update message comprises:
storing the bandwidth information in the binding update message that is updatable by a router located in a connection path between the mobile terminal and the host, such that the host determines a final transmission rate of the data based on the updated bandwidth information.

9. The method as claimed in claim 1, further comprising:
storing the bandwidth information in a QS request message that is updatable by a router located in a connection path between the mobile terminal and the host; and
transmitting the QS request message after the receiving of the data from the host, wherein
the host determines a final transmission rate of the data based on the updated bandwidth information.

10. A computer readable recording medium encoded with the method of claim 1 implemented by a computer.

11. A mobile terminal apparatus to performing a handover from a first network to a second network while receiving data from a remote host, the apparatus comprising:
a network information transfer unit to transmit bandwidth information of the second network to the host; and
a handover performing unit to control the mobile terminal apparatus to perform the handover to the second network after the host receives the bandwidth information, wherein
the mobile terminal apparatus receives the data from the host through the second network with a start transmission rate determined by the host according to the transmitted bandwidth information.

12. The apparatus as claimed in claim 11, wherein the handover performing unit informs the host that the handover is completed.

13. The apparatus as claimed in claim 11, wherein the network information transfer unit:
stores the bandwidth information of the second network in a rate request field comprised in a QS request message that is used in a TCP protocol, and
transmits the QS request message to the host.

14. The apparatus as claimed in claim 13, wherein the network information unit stores information indicating that the QS request message relates to the handover in a reserved field comprised in the QS request message before transmitting the QS request message.

15. The apparatus as claimed in claim 13, wherein the network information unit receives a QS response message from the host to confirm that the host received the bandwidth information before the handover performing unit controls the apparatus to perform the handover.

16. The apparatus as claimed in claim 11, further comprising:
a QS message processing unit to receive a QS request message from the host that recognizes that the handover is completed, to store the bandwidth information in a QS response message that is updatable by a router located in a connection path between the apparatus and the host, and/or to transmit to the host the QS response message in response to the received QS request message, wherein
the host determines a final transmission rate of the data based on the updated bandwidth information.

17. The apparatus as claimed in claim 11, wherein the handover performing unit controls the apparatus to transmit a binding update message to the host to inform the host that the handover is completed.

18. The apparatus as claimed in claim 17, wherein the binding update message stores the bandwidth information that is updatable by a router located in a connection path between the apparatus and the host, such that the host determines a final transmission rate of the data based on the updated bandwidth information.

19. A method of transmitting data to a mobile terminal, the method comprising:
receiving a QS request message from the mobile terminal while transmitting data to the mobile terminal;
determining, when a packet loss occurs, whether the packet loss is caused by a handover of the mobile terminal from a first network to a second network based on the QS request message; and
controlling a transmission rate of the data according to the determining of a cause of the packet loss.

20. The method as claimed in claim 19, wherein the controlling of the transmission rate of the data comprises:
setting the transmission rate according to a rate field value of the QS request message if the packet loss is determined to be caused by the handover of the mobile terminal, and if the handover of the mobile terminal is determined to be completed.

21. The method as claimed in claim 20, further comprising receiving a binding update message from the mobile terminal to determine that the handover of the mobile terminal is completed.

22. The method as claimed in claim 19, further comprising:
transmitting another QS request message comprising a rate request field to store the transmission rate;
receiving a QS response message, comprising the rate request field to store the transmission rate, in response to the transmitted other QS request message; and
adjusting the transmission rate based on the received QS response message, wherein
a router through which the QS response message is transmitted selectively updates the stored transmission rate in the QS response message before the receiving of the QS response message, according to a value of the stored transmission rate.

23. The method as claimed in claim 19, wherein the controlling of the transmission rate of the data comprises:
setting the transmission rate to a smallest transmission unit if the packet loss is determined to not be caused by the handover of the mobile terminal, or if the handover of the mobile terminal is determined to not be completed.

24. A computer readable recording medium encoded with the method of claim 19 implemented by a computer.

25. An apparatus to transmit data to a mobile terminal, the apparatus comprising:
a determination unit to determine, when a packet loss occurs while data is transmitted to the mobile terminal, whether the packet loss is caused by a handover of the mobile terminal from a first network to a second network based on a QS request message received from the mobile terminal; and
a transmission rate control unit to control a transmission rate of the data based on whether the packet loss is caused by the handover.

26. The apparatus as claimed in claim 25, wherein the transmission rate control unit comprises:
a decision unit to set the transmission rate according to a rate field value of the QS request message if the packet loss is determined to be caused by the handover of the mobile terminal, and if the handover of the mobile terminal is determined to be completed.

27. The apparatus as claimed in claim 26, wherein the decision unit receives a binding update message from the mobile terminal if determined that the handover of the mobile terminal is completed.

28. The apparatus as claimed in claim 25, wherein the transmission rate control unit comprises:
a QS message processing unit to generate another QS request message comprising a rate request field to store the transmission rate, to transmit the other QS request message to the mobile terminal, and to receive a QS response message comprising the rate request field to store the transmission rate in response to the other QS request message; and
a transmission rate adjustment unit to adjust the transmission rate based on the received QS response message, wherein
a router through which the QS response message is transmitted selectively updates the stored transmission rate in the QS response message before the QS message processing unit receives the QS response message, according to a value of the stored transmission rate.

29. The apparatus as claimed in claim 26, wherein the decision unit sets the transmission rate to a smallest transmission unit if the packet loss is determined to not be caused by the handover of the mobile terminal, or if the handover of the mobile terminal is determined to not be completed.

30. A system to handover a transmission of data from a first network to a second network, the system comprising:
a mobile terminal to receive the data, to transmit bandwidth information of the second network, and to perform a handover from the first network to the second network after transmitting the bandwidth information; and
a host to transmit the data, to receive the bandwidth information from the mobile terminal, to determine a cause of a packet loss when the packet loss occurs, and to control a transmission rate of the data based on the cause of the packet loss, wherein
the hosts sets the transmission rate according to the bandwidth information when the cause of the packet loss is the handover of the mobile terminal from the first network to the second network, and the handover is completed.

31. The system as claimed in claim 30, wherein the mobile terminal informs the host when the handover is completed.

32. The system as claimed in claim 30, wherein the mobile terminal stores the bandwidth information of the second network in a rate request field comprised in a QS request message and transmits the QS request message.

33. The system as claimed in claim 32, wherein the mobile terminal stores information indicating whether the QS request message relates to the handover in a reserved field comprised in the QS request message before transmitting the QS request message.

34. The system as claimed in claim 33, further comprising:
a first router, located in the first network and in a communication path between the mobile terminal and the host, through which the QS request message is transmitted, wherein
the first router does not change a value of the bandwidth information stored in the rate request field when the reserved field stores information indicating that the QS request message relates to the handover.

35. The system as claimed in claim 32, wherein the host transmits a QS response message to confirm that the host receives the QS request message.

36. The system as claimed in claim 30, further comprising:
a second router located in the second network and in a communication path between the mobile terminal and the host, wherein
the mobile device transmits a message comprising a rate request field storing the bandwidth information to the second router, the second router updates the bandwidth information stored on the message and transmits the updated message to the host, and the host adjusts the transmission rate based on the updated QS response message.

37. The system as claimed in claim 30, wherein the host sets the transmission rate to a smallest transmission unit when the cause of the packet loss is not the handover of the mobile terminal from the first network to the second network, or the handover is not completed.
